(19) United States
(12) Patent Application Publication
(10) Pub. No.: US 2007/0229361 A1
(43) Pub. Date: Oct. 4, 2007

(54) Antenna apparatus

(75) Inventors: Masahiro Yanagi, Shinagawa (JP); Shigemi Kurashima, Shinagawa (JP); Hideki Iwata, Shinagawa (JP); Takashi Yuba, Shinagawa (JP); Masahiro Kaneko, Shinagawa (JP); Yuriko Segawa, Shinagawa (JP); Takashi Arita, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/583,931

(22) Filed: Oct. 20, 2006

(30) Foreign Application Priority Data
Mar. 29, 2006 (JP) 2006-091602

(51) Int. Cl. H01Q 1/38; H01Q 1/48

(52) U.S. Cl. 343/700 MS; 343/846

(57) ABSTRACT

An antenna apparatus is disclosed that includes a dielectric substrate, an antenna element pattern that is formed on an upper face of the dielectric substrate, a strip line that is formed on the upper face of the dielectric substrate and extends from the antenna element pattern, and a ground pattern that is formed on the upper face of the dielectric substrate and is arranged on either side of the strip line. The strip line, the ground pattern, and the substrate form a coplanar microwave transmission line.

### BACKGROUND OF THE INVENTION

1. Field of the Invention

The present invention relates to a planar antenna apparatus for use with UWB (ultra-wide band).

2. Description of the Related Art

In recent years and continuing, much attention is being focused on UWB as a wireless communications technology enabling radar positioning and broadband communications, for example. In 2002, the U.S. Federal Communication Commission (FCC) approved usage of the UWB within a frequency band of 3.1-10.6 GHz.

The UWB is a wireless communications technology that involves transmitting pulse signals across a very wide frequency band. Therefore, an antenna used for UWB communication has to be capable of transmitting and receiving signals within a very wide frequency band.

It is noted that in “An Omnidirectional and Low-VSWR Antenna for the FCC-Approved UWB Frequency Band” by Takuya Taniguchi and Takehiko Kobayashi (IEEE Antennas and Propagation Society International Symposium, 2003), an antenna is disclosed that comprises a ground plane and a feed element which antenna is adapted for use in the FCC-approved frequency band of 3.1-10.6 GHz.

FIGS. 1A and 1B are diagrams showing examples of conventional antenna apparatuses. The antenna apparatus 10 shown in FIG. 1A includes a ground plane 11 and a feed element 12 having a circular cone shape that is arranged on the ground plane 11. The circular cone shape of the feed element 12 is arranged such that the side face forms an angle of θ degrees with respect to the axis of the cone. It is noted that desired antenna properties may be obtained by adjusting the angle θ.

The antenna 20 shown in FIG. 1B includes a ground plane 11 on which a conical part 22a and a spherical part 22b internally touching the conical part 22a are arranged, the conical part 22a and the spherical part 22b forming a tear-shaped feed element 22.

As is described above, a conventional broadband antenna apparatus is constructed by arranging a cone-shaped or tear-shaped feed element on a flat ground plane. The antenna apparatus constructed in such a manner is rather large so that techniques for miniaturizing and flattening the antenna apparatus are in demand.

FIGS. 2A and 2B are diagrams showing a basic structure of an exemplary UWB planar antenna apparatus. As can be appreciated from these drawings, the illustrated UWB planar antenna apparatus 30 is reduced in size and thickness compared to the conventional antenna apparatuses 10 and 20 shown in FIGS. 1A and 1B.

The UWB planar antenna apparatus 30 includes a dielectric substrate 31 having an upper face 31a on which a home-plate-shaped antenna element pattern 32 and a microstrip line 33 extending from the antenna element pattern 32 are formed. Also, the substrate 31 has a bottom face 31b on which a ground pattern 34 is formed opposite the microstrip line 33. It is noted that a core wire 41 of a coaxial cable 40 is soldered to the end of the microstrip line 33 by solder 50. Also, the sheath wire of the coaxial cable 40 is soldered to the ground pattern 34. It is noted that the thickness of the substrate 31 is no more than 0.1 mm.

The microstrip line 33 is arranged opposite the ground pattern 34 via the substrate 31 and forms a microwave transmission line. The microwave transmission line is designed to have an impedance of 50Ω.

FIGS. 3A-3C show data for designing a microstrip line with an impedance of 50Ω. As can be appreciated from these drawings, in order to achieve an impedance of 50Ω, the microstrip line 33 has to have a relatively narrow width W of around 0.1 mm.

When the width W of the microstrip line 33 is relatively narrow, the solder 50 connecting the core wire 41 of the coaxial cable 40 may spread outside the microstrip line 33.

When the solder 50 spreads outside the microstrip line 33, the impedance of the soldered portion may deviate from 50Ω, and a portion of the microwave transmitted by the microstrip line 33 may be reflected by the soldered portion. Such an effect has been the cause of degradation in the properties of the UWB planar antenna apparatus 30.

### SUMMARY OF THE INVENTION

According to an aspect of the present invention, an antenna apparatus is provided that is adapted to prevent antenna property degradation resulting from influences of a soldered portion.

According to one embodiment of the present invention, an antenna apparatus is provided that includes:

an antenna element pattern;

a ground pattern that is arranged opposite the antenna element pattern; and

a coplanar microwave transmission line that extends from the antenna element pattern.

According to another embodiment of the present invention, an antenna apparatus is provided that includes:

a dielectric substrate;

an antenna element pattern that is formed on an upper face of the dielectric substrate;

a strip line that is formed on the upper face of the dielectric substrate and extends from the antenna element pattern; and

a ground pattern that is formed on the upper face of the dielectric substrate and is arranged on either side of the strip line;

wherein the strip line, the ground pattern, and the substrate form a coplanar microwave transmission line.

In one aspect of the present invention, by employing a coplanar microwave transmission line as the microwave transmission line, the strip line of the microwave transmission line may be arranged to have a relatively large width of approximately 1 mm, for example, so that solder used to connect a center conductor of a coaxial connector to the end of the strip line may be prevented from spreading outside the strip line. Accordingly, the impedance of the soldered portion may be arranged to be the same as the impedance of the microwave transmission line so that degradation of antenna properties due to influences of the soldered portion may be prevented.

### BRIEF DESCRIPTION OF THE DRAWINGS

FIGS. 1A and 1B are diagrams showing examples of conventional antenna apparatuses;

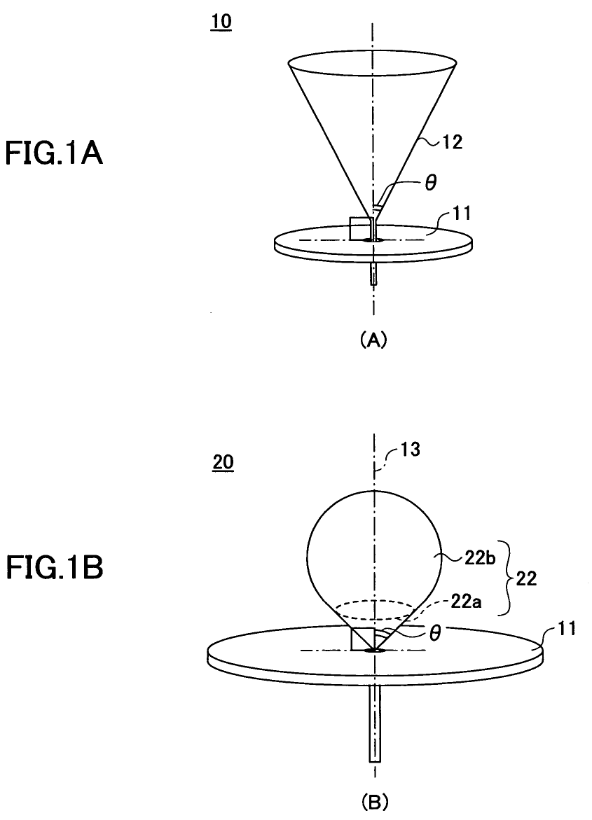

FIGS. 2A and 2B are diagrams showing the structure of a UWB planar antenna apparatus;

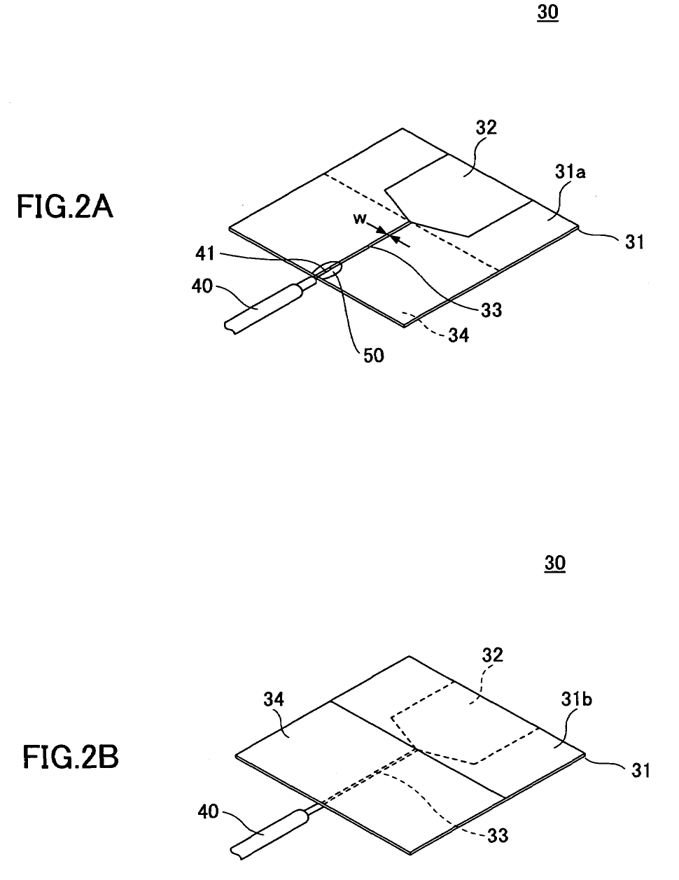

FIGS. 3A-3C are diagrams showing data for designing a microstrip line having an impedance of 50Ω;

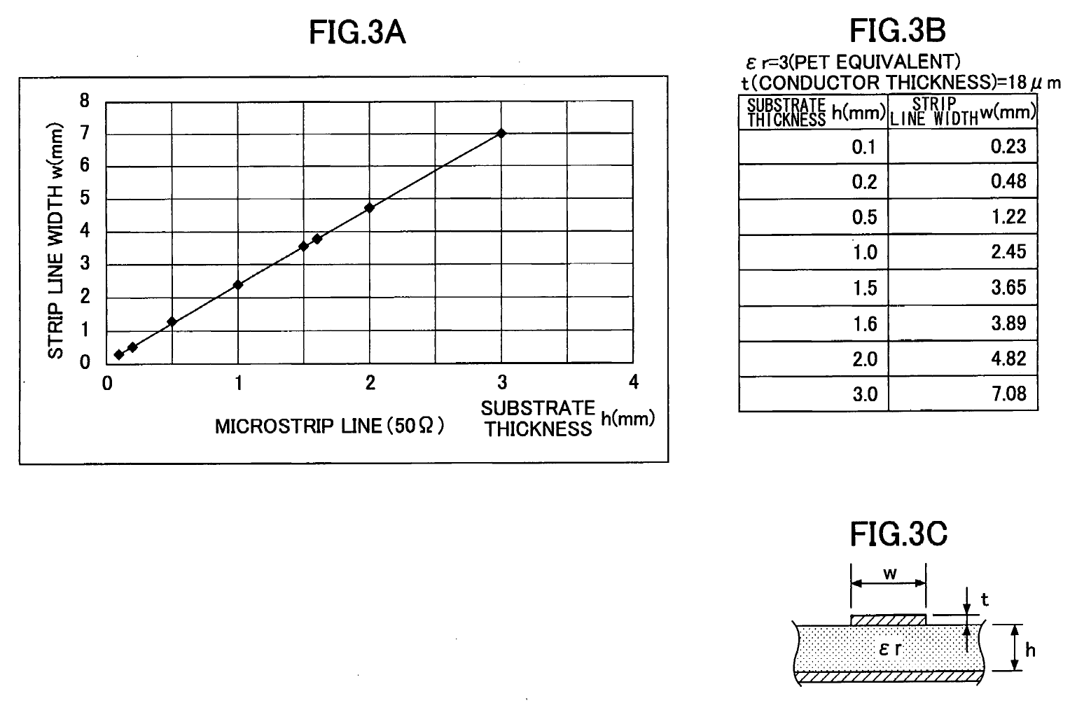

FIGS. 4A and 4B are perspective views of a UWB planar antenna apparatus according to a first embodiment of the present invention;

FIGS. 5A-5C are diagrams showing the structure of the UWB planar antenna apparatus of the first embodiment;

FIG. 6 is a graph showing a VSWR-frequency relationship of the UWB planar antenna apparatus of the first embodiment;

FIGS. 7A-7C are diagrams showing data for designing a coplanar strip line having an impedance of 50Ω;

FIGS. 8A and 8B are perspective views of a UWB planar antenna apparatus according to a second embodiment of the present invention;

FIGS. 9A-9C are diagrams showing the structure of the UWB planar antenna apparatus of the second embodiment; and

FIGS. 10A-10C are diagrams showing a socket coaxial connector used in the UWB planar antenna apparatus of the second embodiment.

### DESCRIPTION OF THE PREFERRED EMBODIMENTS

In the following, preferred embodiments of the present invention are described with reference to the accompanying drawings.

### First Embodiment

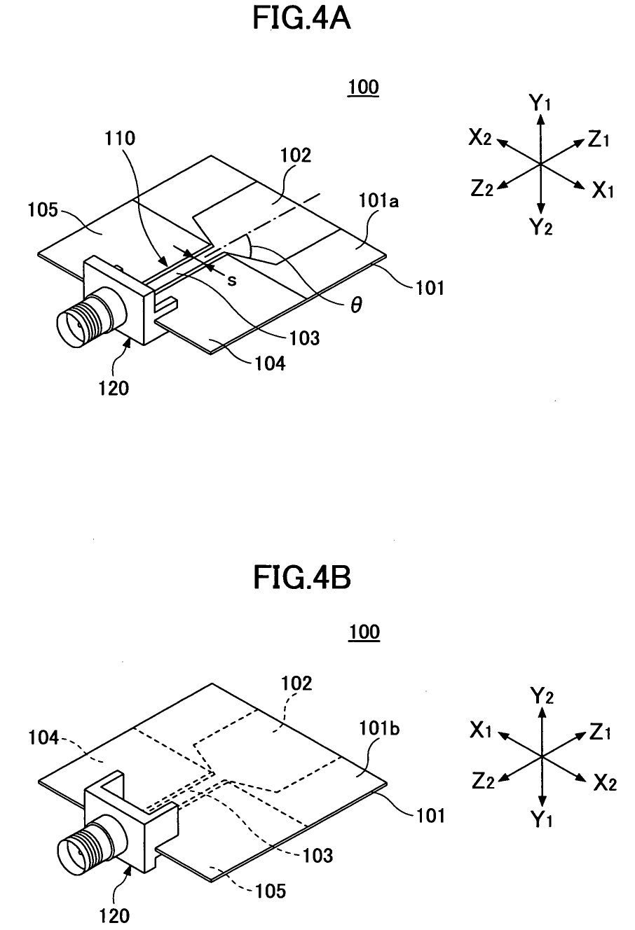

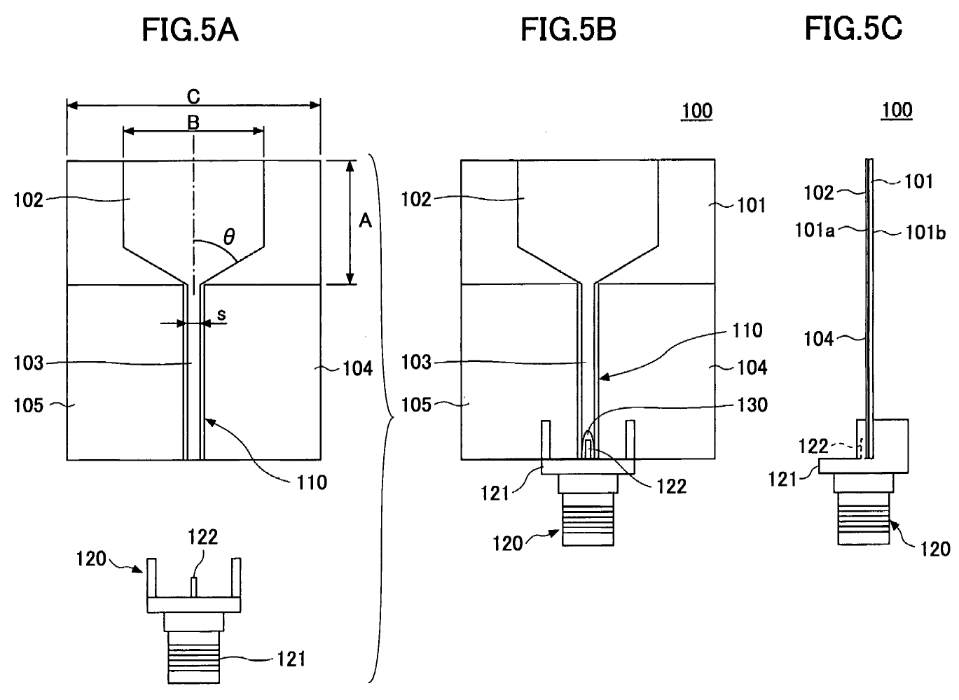

FIGS. 4A, 4B, and FIGS. 5A-5C are diagrams illustrating a UWB planar antenna apparatus 100 according to a first embodiment of the present invention. The illustrated UWB planar antenna apparatus 100 includes a dielectric substrate 101 having an upper face 101a on which an antenna element pattern 102, a strip line 103, and two ground patterns 104 and 105 are formed. Also, a coaxial connector 120 is fixed to the end of the substrate 101. It is noted that elements are not arranged on the bottom face 101b of the substrate 101 in the present embodiment.

The coaxial connector 120 includes a metal main frame (external conductor) 121, a center conductor 122 that penetrates through the main frame 121, and a dielectric portion (not shown) that is arranged around the center conductor 122. The coaxial connector 120 is arranged to have an impedance of 50Ω.

It is noted that in FIGS. 4A and 4B, directions Z1-Z2 represent the axis line directions of the UWB antenna 100 (i.e., length directions of the substrate 101), directions X1-X2 represent width directions of the substrate 101, and directions Y1-Y2 represent thickness directions of the substrate 101.

The antenna element pattern 102 is configured to have a home-plate shape. The strip line 103 extends in the Z2 direction from a protrusion (feed point) of the antenna element pattern 102. The ground patterns 104 and 105 are rectangular shaped patterns arranged adjacent to the antenna element pattern 102 with respect to the Z1-Z2 directions. The ground patterns 104 and 105 are divided by the strip line 103 to be positioned on the X1 side and the X2 side, respectively.

The ground patterns 104 and 105 form ground potential portions at positions close to the antenna element pattern 102. The ground patterns 103 and 104 enable electric flux lines to be formed around the antenna element pattern 102, and portions thereof that are arranged along the strip line 103 make up a part of a coplanar microwave transmission line 110, which is described below.

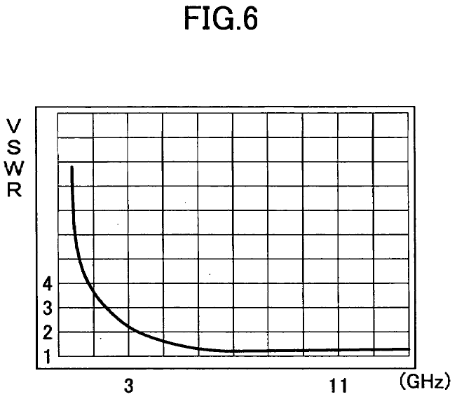

Referring to FIG. 5A, the input impedance to the antenna element pattern 102 depends upon the opening angle θ of a feed point portion, and this angle θ is arranged to be approximately 60 degrees. It is noted that the minimum frequency of the antenna apparatus 100 is determined by dimension A of the antenna element pattern 102, and the broadband properties of the antenna apparatus 100 are determined by dimensions B and C of the antenna element pattern 102. FIG. 6 is a graph illustrating a VSWR (Voltage Standing Wave Ratio)-frequency relationship of the UWB planar antenna apparatus 100 of the present embodiment. As can be appreciated from this drawing, the VSWR in the frequency band of 3.1-10.6 GHz is no more than 1.4. Also, it is noted that the UWB planar antenna apparatus 100 is omnidirectional in the X-Y plane.

The strip line 103, the ground patterns 104 and 105 arranged at the two sides of the strip line 103, and the substrate 101 comprise a coplanar microwave transmission line 110 with an impedance of 50Ω.

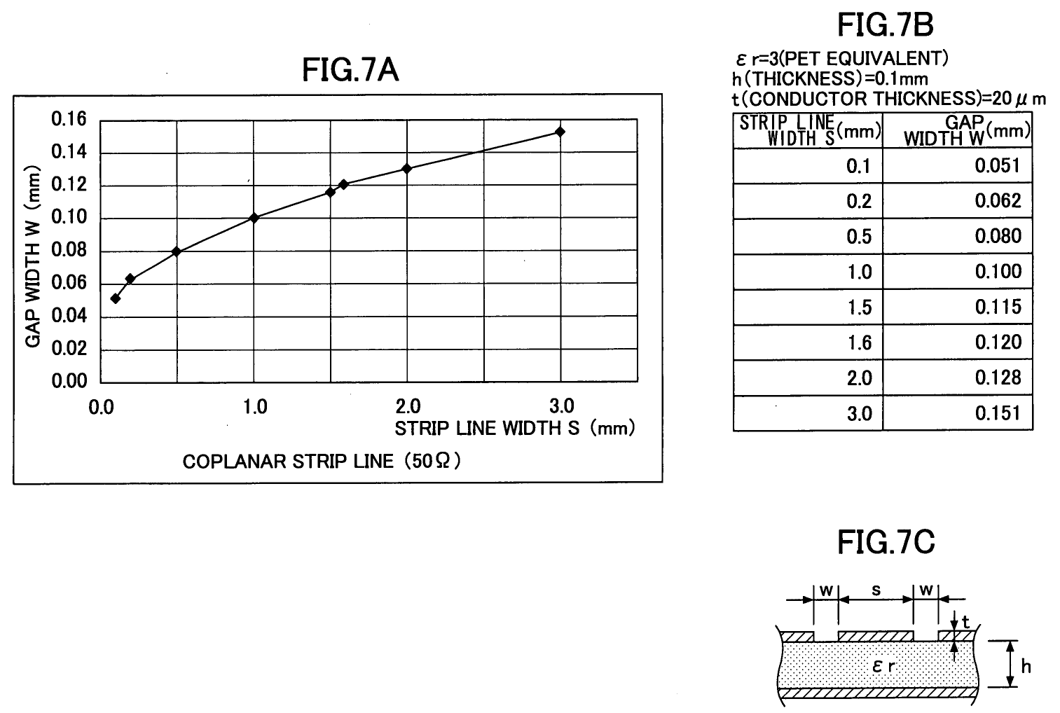

FIGS. 7A-7C show data for designing a coplanar strip line with an impedance of 50Ω. As can be appreciated from these drawings, the strip line 103 may be arranged to have a relatively large strip line width S of approximately 1 mm. In the following descriptions, the strip line width S of the strip line 103 is assumed to be approximately 1 mm.

The coaxial connector 120 is fixed to the end of the substrate 101 by having the center conductor 122 connected to the end of the strip line 103 by solder 130, and a flared portion 121a of the main frame 121 soldered to the ground patterns 104 and 105.

Since the strip line 103 has a relatively wide width S of approximately 1 mm in the present example, the solder 130 may be adequately accommodated within the width S of the strip line 103 so that the solder may be prevented from spreading outside the strip line 103.

Accordingly, the impedance of the portion of the coaxial connector 120 that is soldered to the coplanar microwave transmission line 110 may be 50Ω; that is, the impedance of the soldered portion may be prevented from deviating from the desired level. In this way, a portion of the microwaves transmitted by the strip line 103 being reflected by the soldered portion may be prevented so that degradation of the properties of the UWB planar antenna apparatus 100 may be prevented. Therefore, the antenna properties of the UWB planar antenna apparatus 100 may be maintained at a desirable level.

The UWB planar antenna apparatus 100 may be used by connecting a coaxial connector (not shown) of a coaxial cable (not shown) to the coaxial connector 120. In this case, a high frequency signal is supplied to the antenna element pattern 102, the ground patterns 104 and 105 are set to ground potential, and electric flux lines are created between the antenna element pattern 102 and the ground patterns 104, 105.

It is noted that in an alternative arrangement, the end of the coaxial cable may be directly soldered to the microwave transmission line 110.

### Second Embodiment

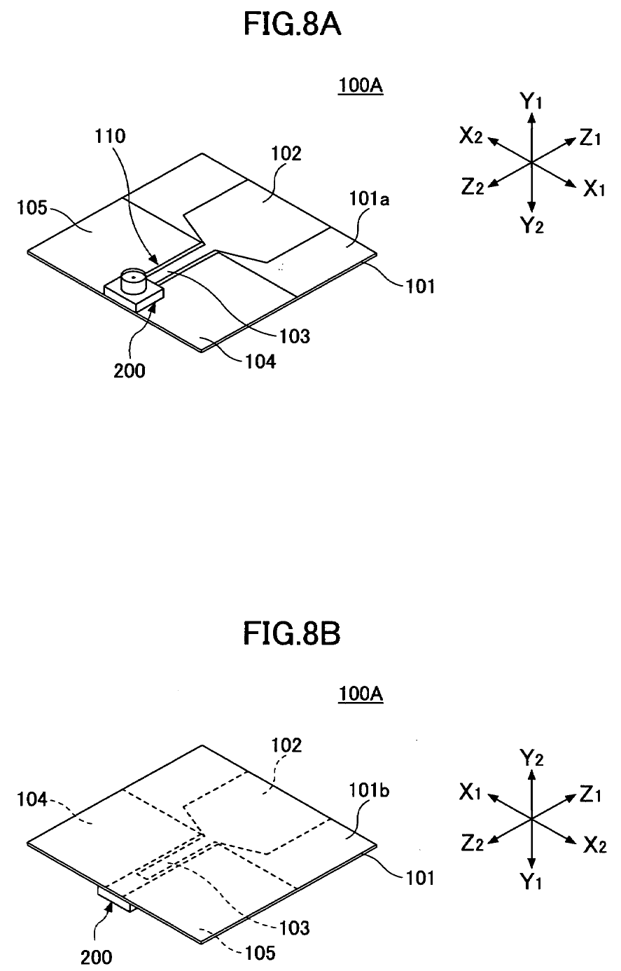

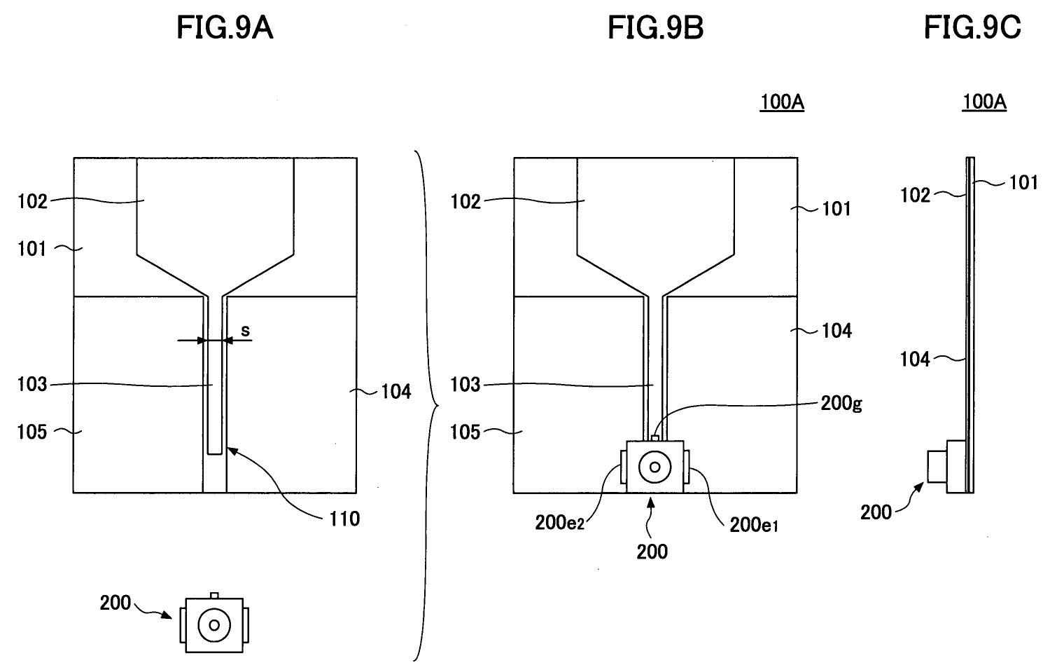

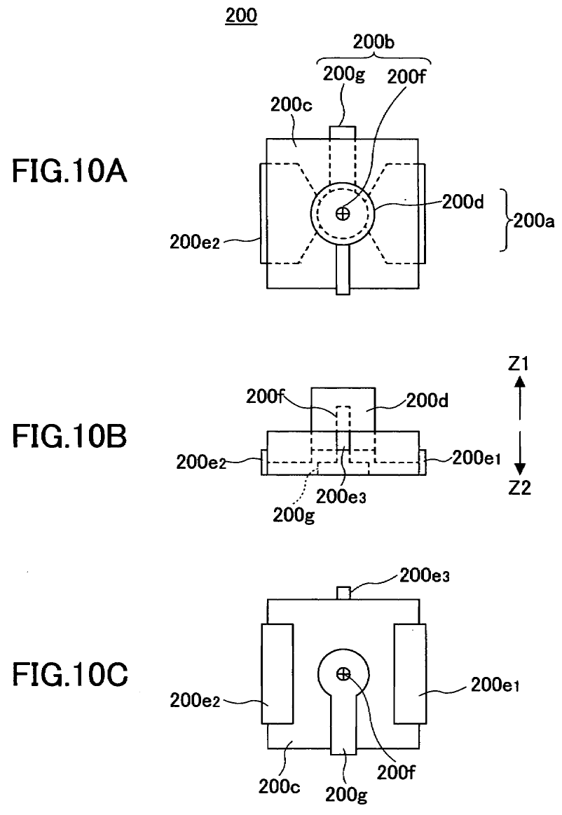

FIGS. 8A, 8B, and FIGS. 9A-9C are diagrams showing a UWB planar antenna 100A according to a second embodiment of the present invention. The illustrated UWB planar antenna apparatus 100A differs from the UWB planar antenna apparatus 100 of the first embodiment in that it employs a socket coaxial connector 200 as is shown in FIGS. 10A-10C in place of the coaxial connector 120. It is noted that components of the UWB planar antenna apparatus 100A that are identical to those of the UWB planar antenna apparatus 100 are given the same numerical references and their descriptions are omitted. Also, in FIGS. 8A and 8B, directions Z1-Z2 represent the axis line directions of the UWB planar antenna 100A (i.e., length directions of the substrate 101), directions X1-X2 represent width directions of the substrate 101, and directions Y1-Y2 represent thickness directions of the substrate 101.

As is shown in FIG. 9A, in the UWB planar antenna 100A of the present embodiment, the strip line 103 is reduced in length in order to accommodate the socket coaxial connector 200.

As is shown in FIGS. 10A-10C, the socket coaxial connector 200 is a surface-mounted connector including a shield part 200a and a signal line connecting part 200b that are integrally molded with an insulating part 200c.

The shield part 200a is made of conductive material and includes a connecting part 200d and contact parts 200e1, 200e2, and 200e3. The connecting part 200d is cylindrically shaped and extends in the direction of arrow Z1 to engage a shield of a plug connector (not shown). The contact parts 200e1, 200e2, and 200e3 are connected to the connecting part 200d and exposed from the bottom face side of the insulating part 200c, namely, the side facing the direction of arrow Z2.

The signal line connecting part 200b is made of conductive material and includes a center conductor 200f and a contact part 200g. The center conductor 200f extends from the insulating part 200c toward the direction of arrow Z2 within the perimeter of the connecting part 200d. The center conductor 200f is connected to the signal line of the plug connector when the plug connector is connected to the socket coaxial connector 200. The contact part 200g is connected to the center conductor 200f and exposed from the bottom face side of the insulating part 200c, namely, the side facing the direction of arrow Z2.

The socket coaxial connector 200 is surface mounted on the substrate 101 (coplanar microwave transmission line 110) by soldering the contact part 200g to the end of the strip line 103, the contact part 200e1 to the ground pattern 104, and the contact part 200e2 to the ground pattern 105.

It is noted that the strip line 103 may have a relatively large width S of approximately 1 mm in the present example so that the contact part 200g may be soldered to the end of the strip line 103 so that the solder used for connecting the contact part 200g to the strip line 103 may be accommodated within the width S of the strip line 103 and prevented from spreading outside the strip line 103.

In this way, the impedance of the portion at which the socket coaxial connector 200 is soldered to the coplanar microwave transmission line 110 maybe 50Ω. Thus, a portion of the microwaves transmitted by the strip line 103 being reflected by the soldered portion may be prevented so that degradation of the properties of the UWB planar antenna apparatus 100A may be prevented and desirable antenna properties may be maintained.

It is noted that since the UWB planar antenna 100A has the socket coaxial connector 200 surface-mounted on its substrate 101, the UWB planar antenna 100A may be reduced in size compared to the UWB planar antenna 100 of the first embodiment.

Also, it is noted that the UWB planar antenna 100A may be used by connecting a plug coaxial connector (not shown) arranged at the end of a coaxial cable (not shown) to the socket coaxial connector 200.

Further, the present invention is not limited to these embodiments, and variations and modifications may be made without departing from the scope of the present invention.

The present application is based on and claims the benefit of the earlier filing date of Japanese Patent Application No. 2006-091602 filed on Mar. 29, 2006, the entire contents of which are hereby incorporated by reference.

What is claimed is:

1. An antenna apparatus comprising:
an antenna element pattern;
a ground pattern that is arranged opposite the antenna element pattern; and
a coplanar microwave transmission line that extends from the antenna element pattern.

2. An antenna apparatus comprising:
a dielectric substrate;
an antenna element pattern that is formed on an upper face of the dielectric substrate;
a strip line that is formed on the upper face of the dielectric substrate and extends from the antenna element pattern; and
a ground pattern that is formed on the upper face of the dielectric substrate and is arranged on either side of the strip line;
wherein the strip line, the ground pattern, and the substrate form a coplanar microwave transmission line.

3. The antenna apparatus as claimed in claim 2, further comprising:
a coaxial connector that is fixed to the substrate, the coaxial connector including a center conductor that is soldered to an end of the strip line the substrate.

4. An antenna apparatus as claimed in claim 2, further comprising:
a surface-mounted coaxial connector that is fixed to the substrate, the surface-mounted coaxial connector including a center conductor and a contact extending from the center conductor which contact is soldered to an end of the strip line.
